(19) United States
(12) Patent Application Publication
(10) Pub. No.: US 2016/0297454 A1
(43) Pub. Date: Oct. 13, 2016

(54) DIAGNOSTIC SYSTEM FOR TRAIN

(71) Applicant: Electro-Motive Diesel Inc., LaGrange, IL (US)

(72) Inventors: Alexander Shubs, JR., Chicago, IL (US); David M. Roenspies, Elburn, IL (US); James D. Seaton, Westmont, IL (US)

(73) Assignee: Electro-Motive Diesel Inc., LaGrange, IL (US)

(21) Appl. No.: 15/188,448

(22) Filed: Jun. 21, 2016

(51) Int. Cl. B61L 15/00; G07C 5/00; G07C 5/08

(52) U.S. Cl. CPC B61L 15/0081; B61L 15/0072; B61L 15/0018; G07C 5/0808; G07C 5/0816; G07C 5/008

(57) ABSTRACT

A diagnostic system associated with a train is provided. The train is in communication with a remote control station. The train includes a plurality of wagons and locomotives. A diagnostic module on-board the wagons generate a signal indicative of operational data and health data. A communication module on-board the slave rolling stock transmits the operational data and the health data associated with the slave rolling stock to the master control module. The master control module exchanges the operational data and the health data with another master control module located on the same train and another train; and forwards the operational data and the health data associated with the slave rolling stock and the master control module to the remote control station.

### TECHNICAL FIELD

The present disclosure relates to a diagnostic system, and more specifically, to the diagnostic system for monitoring health data and operational data of a train.

### BACKGROUND

Trains may be comprised of a multitude of locomotives, wagons, tankers, and other rolling stock. A train is controlled by a lead locomotive. The locomotives may include multiple sub-systems and components such as an engine, a fuel supply, doors, lights, an intercom, a braking module, an air conditioner, a power source, a signaling sub-system, and an exhaust sub-system. Typically, the locomotive may include an on-board monitoring system to monitor these multiple sub-systems and components, in order to generate data related to their faults and operational parameters. Further, the locomotive may also include an on-board communication system to communicate such data to a back office control center. The locomotive may communicate data from an entire train to the back office control center. The back office control center may analyze the received data and initiate a corrective action for any diagnosed faults, if necessary for each locomotive.

Currently, the communication between the on-board communication system of the locomotive and the back office control center is established using a number of communication techniques such as, but not limited to, Global Satellite Positioning (GPS), radio communication, and cellular communication. However, such communication between the on-board communication system of the locomotive and the back office control center may experience poor connectivity or failure due to various reasons such as, lack of communication infrastructure in certain locations, geographical profile of a location such as hilly terrain or tunnels, etc, Due to limited network coverage of the communication system and presence of obstacles, amongst other factors, the communication between the locomotive and the back office control center may be severely affected or lost.

U.S. Pat. No. 8,428,798 describes a train control system. The train control system includes a communication device associated with at least one control unit located on a first train and a communication device associated with at least one control unit located on a second train. At least one control unit of the first train or the second train is configured to receive an authority signal via the associated communication device. The authority signal includes data sufficient to identify one of the trains as a lead train and the other as a follower train. Further, the at least one control unit of the first train and the second train is configured to establish at least one peer-to-peer communication link between the communication devices of the lead train and the follower train. The at least one control unit of the first train and the second train is configured to exchange train data between the lead train and the follower train via the at least one peer-to-peer communication link.

However, such known solutions may not provide ways for continuous communication among the trains and the back office control center. Hence, an improved communication system is required to maintain continuous communication between the trains and the back office control center for sharing data of the trains.

### SUMMARY OF THE DISCLOSURE

In one aspect of the present disclosure, a diagnostic system associated with a train is provided. The train is in communication with a remote control station, The train may include a plurality of locomotives, wagons, tankers, and other rolling stock. Control of the rolling stock within the train is accomplished by a master control module, usually located on a lead locomotive. The remaining rolling stock can be designated as a slave rolling stock. The diagnostic system includes a diagnostic module on-board each of the plurality of wagons and the locomotives of the train. The diagnostic module is configured to generate a signal indicative of at least one of operational data and health data associated with the corresponding wagon or the locomotives of the train. A communication module is provided on-board the slave rolling stock. The slave rolling stock is configured to transmit the at least one of the operational data and the health data associated with the slave rolling stock to at least one of the master control module and the remote control station. The communication module is further provided on-board the master control module. The master control module is configured to exchange the at least one of the operational data and the health data associated with the master control module with another master control module located on at least one of the same train and another train. The master control module is configured to forward the at least one of the operational data and the health data associated with the slave rolling stock to the remote control station. The master control module is configured to transmit the at least one of the operational data and the health data associated with the master control module to the remote control station.

Other features and aspects of this disclosure will be apparent from the following description and the accompanying drawings.

### BRIEF DESCRIPTION OF THE DRAWINGS

FIG. 1 is a pictorial view of an exemplary train, in accordance with the concepts of the present disclosure;

FIG. 2 is a schematic diagram of a diagnostic system associated with the train of FIG. 1, in accordance with the concepts of the present disclosure; and

FIG. 3 is a schematic diagram of another diagnostic system associated with multiple trains, in accordance with the concepts of the present disclosure.

### DETAILED DESCRIPTION

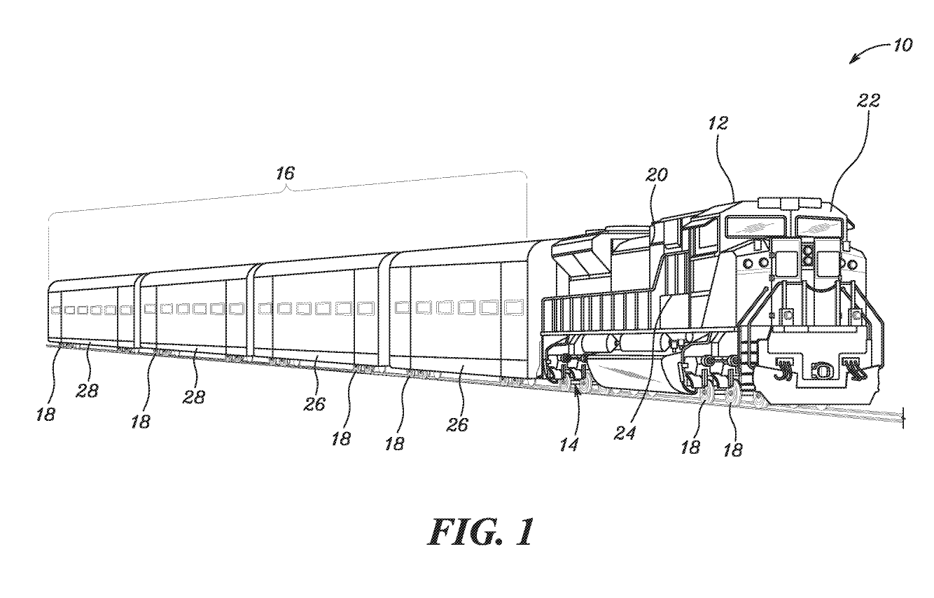

Referring to FIG. 1, an exemplary train 10 is illustrated. The train 10 includes a locomotive 12. chassis 14, and a number of wagons 16. The locomotive 12 and the wagons 16 have a number of wheels 18. Further, the locomotive 12 includes a body 20, an operator's cab 22, and a walking platform 24. The train 10 further includes various other components such as, but not limited to, a number of doors and windows. For the purpose of simplicity, the various other components of the train 10 are not labeled in FIG. 1. It should be noted that the train 10 may include more than one locomotive 12 as well, without departing from the scope of the disclosure.

The train 10 includes the locomotive 12 having a combustion engine (not shown), specifically a diesel engine, which drives an alternator (not shown). The alternator provides electrical power to traction motors (not shown), which are mounted on the chassis 14 in order to drive the wheels 18. Further, the locomotive 12 has the operator's cab 22 and the walking platform 24 that surrounds the body 20 of the locomotive 12. It should be noted that the locomotive 12 may be an electric locomotive as well, without departing from the scope of the disclosure.

The train 10 further includes the wagons 16 which are coupled to each other. One of the controlling rolling stock, either the locomotive 12 or the wagons 16, is designated as a master control module 26 and each of the remaining rolling stock is designated as a slave rolling stock 28. The designation of the wagons 16 as the master control module 26 or the slave rolling stock 28 is pre-determined and may be accomplished using known techniques. The distribution of the master control modules 26 and the slave rolling stock 28 in the accompanying figures is merely on an exemplary basis and does not limit the scope of the present disclosure, In the illustrated embodiment, one of the master control modules 26 is coupled to the locomotive 12 of the train 10. Alternatively, one of the slave rolling stock 28 may be coupled to the locomotive 12 of the train 10. In one embodiment, the master control module 26 may be the locomotive 12 of the train 10. The wagons 16 are utilized for carrying goods or services, or carrying passengers from one location to another.

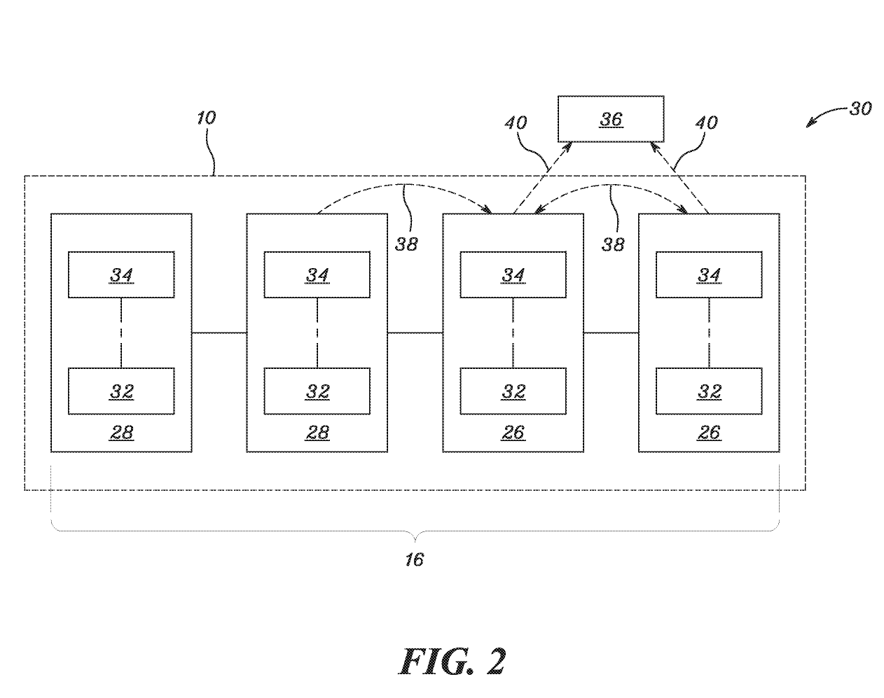

Referring to FIG. 2, a diagnostic system 30 is associated with the train 10. The train 10 is in communication with a remote control station 36. The diagnostic system 30 includes a diagnostic module 32 and a communication module 34. It should be noted that each one of the wagons 16 may communicate with the remote control station 36 via a communication network (not shown). The communication network may include, but not limited to, a fourth-generation (4G) cellular communication network, a third-generation (3G) cellular communication network, a radio communication network, and a Global Satellite Positioning (GPS) communication network.

The diagnostic module 32 is provided on-board each one of the wagons 16, or the locomotives 12, of the train 10. The diagnostic module 32 includes a number of sensors (not shown) associated with the wagons 16 of the train 10. During an operation of the train 10, the sensors are configured to monitor various components of the wagons 16 of the train 10 and generate an operational data related to the wagons 16. For example, the operational data includes, but not limited to, an operational status of a Heating Ventilation and Air Conditioning (HVAC) system of the wagons 16, alighting status of the wagons 16, open or close status of doors of the wagons 16, and a current location of the wagons 16,

Further, the sensors are configured to monitor various components and sub-systems such as, but not limited to, the wheels 18, an electrical subsystem, a power supply sub-system, and a signaling sub-system, of the wagons 16 or the locomotives 12 of the train 10. Based on the monitoring, the sensors may generate health data associated with the wagons 16 or the locomotives 12 of the train 10, The health data includes, but not limited to, temperature of the wheels 18 of the wagons 16, a status of electrical switches of the wagons 16, voltage of the power supply sub-system of the wagons 16, a status of a traction system of the train 10, and fault codes associated with components such as fuel injectors. It will be apparent to one skilled in the art that the operational data and the health data mentioned above have been provided only for explanation purposes on an exemplary basis. The operational data and the health data may include other information related to the wagons 16 and/or locomotive 12 (see FIG. 1) of the train 10 as well, without departing from the scope of the disclosure.

The communication module 34 is provided on-board the slave rolling stock 28 and is communicably coupled with the diagnostic module 32 of the corresponding slave rolling stock 28. The communication module 34 may be utilized to communicate directly with the remote control station 36 and/or with the master control modules 26 as the case may be. Accordingly, the communication module 34 is configured to receive the signal indicative of the operational data and/or the health data associated with the slave rolling stock 28 of the train 10. This operational data and/or the health data is received by the communication module 34 from the diagnostic module 32 of the same slave rolling stock 28. After receiving the signal indicative of the operational data and/or the health data associated with the slave rolling stock 28, the communication module 34 is configured to transmit the operational data and/or the health data associated with the slave rolling stock 28 to the master control module 26, the remote control station 36, or both.

In one example, the location of the train 10 with respect to the remote control station 36 may be such that the train 10 lies outside a range of the communication network. Alternatively, there may be other reasons due to which the train 10 may be unable to communicate directly with the remote control station 36. Thus, in this situation, the master control module 26 of the train 10 establishes a peer-to-peer communication link 38 with one of the master control modules shown) of another train (not shown). After establishing the peer-to-peer communication link 38, the master control module 26 transmits the operational data and/or the health data associated with the train 10 to another master control module.

In another scenario, if the master control module 26 is unable to communicate directly with the remote control station 36, then the master control module 26 establishes the peer-to-peer communication link 38 with another master control module 26 located on the train 10. As described earlier, this situation may arise when the master control module 26 is outside of a coverage area of the communication network and/or the master control module 26 is unable to establish a reliable direct communication with the remote control station 36. Accordingly, after establishing the peer-to-peer communication link 38, the master control module 26 transmits the operational data and/or the health data associated with the master control module 26 of the train 10 to another master control module 26 located on the train 10 for further transmission to the remote control station 36 via a communication link 40. The master control modules 26 on the train 10 may thus be capable of exchange of the operational data and/or the health data with other master control modules 26 of the train 10. Based on the requirements of the situation, the master control module 26 may either transmit or receive the operational data and/or the health data for further transmission to the remote control station 36.

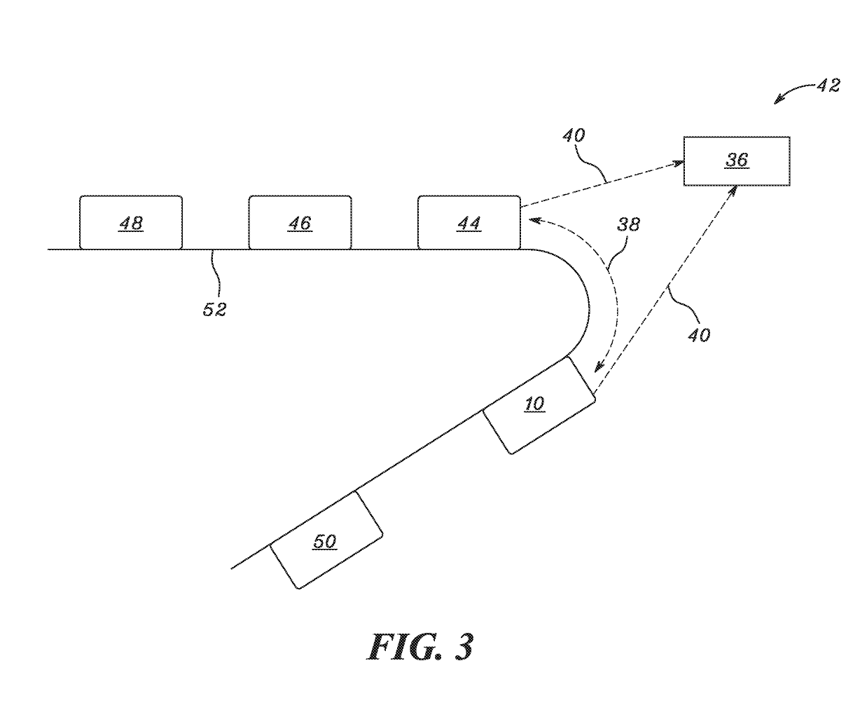

FIG. 3 is another exemplary implementation of a diagnostic system 42 across multiple trains. The diagnostic system 42 is associated with the train 10, as well as other trains including a second train 44, a third train 46, a fourth train 48, and a fifth train 50, hereinafter collectively referred to as trains 10, 44, 46, 48, 50. Each of the trains 10, 44, 46, 48, 50 is traversing on a rail track 52. As discussed above, each of the trains 10, 44, 46, 48, 50 includes the locomotives 12 and the wagons 16 having the diagnostic module 32 see FIG. 2), and the communication module 34 (see FIG. 2) have the capabilities of the diagnostic system 30 as described above in connection with the train 10.

In a scenario, if each of the trains 10, 44, 46, 48, 50 lies within the range of the communication network of the remote control station 36 such that a strong and a reliable communication link can be established, each of the trains 10, 44, 46, 48, 50 may directly communicate with the remote control station 36. Accordingly, each of the trains 10, 44, 46, 48, 50 may directly transmit the operational data and/or the health data associated with the corresponding trains 10, 44, 46, 48, 50 to the remote control station 36 via the communication link established between the respective trains 10, 44, 46, 48, 50 and the remote control station 36. In the accompanying figures, the direct communication links 40 between the train 10 and the remote control station 36, and the second train 44 and the remote control station 36 have been illustrated for exemplary purposes, without limiting the scope of the present disclosure.

In another scenario, the location of the train 10 with respect to the remote control station 36 may be such that the train 10 lies outside a range of the communication network. Alternatively, the train 10 may be in a tunnel due to which the train 10 may be unable to communicate directly with the remote control station 36. Thus, in this situation, the train 10 establishes the peer-to-peer communication link 38 with the second train 44. Accordingly, after establishing the peer-to-peer communication link 38, the master control module 26 (see FIG. 2) of the train 10 transmits the operational data and/or the health data to another master control module (not shown) of the second train 44. Thereafter, the second train 44 communicates directly with the remote control station 36 via the communication network to transmit the operational data and/or the health data. associated with the master control module 26 of the train 10 with the remote control station 36.

It will be apparent to one skilled in the art that the train 10 and the second train 44 communicate with each other via the peer-to-peer communication link 38 for exchanging the operational data and/or the health data mentioned above have been provided only for explanation purposes on an exemplary basis. Each of the trains 10, 44, 46, 48, 50 may thus be capable of exchange of the operational data and/or the health data with each other via the peer-to-peer communication link 38, without departing from the scope of the disclosure.

In another embodiment, it may also be contemplated that the each of the trains 10, 44, 46, 48, 50 may have the diagnostic module 32 and the communication module 34 in their respective locomotives 12. In an event of unavailability of network for any one of these trains 10, 44, 46, 48, 50, high priority data, i.e., the operational data and/or the health data, may be communicated to the remote control station 36 via, any of the other neighboring trains that are in the peer-to-peer communication link 38 with the present train. Since, the respective locomotives 12 of the neighboring trains are in direct communication with the remote control station 36 and also in communication with the present train via the peer-to-peer communication link 38, the high priority data i.e., the operational data and/or the health data may still reach the remote control station 36 in time, despite disruptions in the direct communication between the present train and the remote control station 36.

### INDUSTRIAL APPLICABILITY

The present disclosure provides the diagnostic systems 30, 42 associated with the train 10 and the multiple trains respectively. The diagnostic system 30 enables communication between the wagons 16 of the train 10 and the remote control station 36 by developing the peer-to-peer communication link 38 between the wagons 16 of the train 10. Similarly, the diagnostic system 42 establishes the communication between the trains 10, 44, 46, 48, 50, and the remote control station 36 by developing the peer-to-peer communication link 38 between the trains 10, 44, 46, 48, 50, The peer-to-peer communication link 38 between the wagons 16 of the train 10, or between the trains 10, 44, 46, 48, 50, allows for transmission of the operational data and/or the health data to the remote control station 36 even when no direct communication may be possible between the remote control station 36 and the respective train or wagon.

Additionally, each of the trains 10, 44, 46, 48, 50 may transmit and/or receive data such as, but not limited to, control commands to/from the remote control station 36 as well. Further, the diagnostic systems 30, 42 may reduce delay in transfer of the operational data and/or the health data (that may affect overall working of the train 10) from reaching the remote control station 36 even when there may be disruption in communication between the wagons 16 and the remote control station 36. Thus, the diagnostic systems 30, 42 may facilitate continuous communication between the wagons 16 of the train 10 and the remote control station 36; and/or between the trains 10, 44, 46, 48, 50 and the remote control station 36, even in locations where communication infrastructure has limited or close to no connectivity due to various reasons such as, hilly terrain or tunnels.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed, Such embodiments should be understood to fall within the scope of the present disclosure as determined based upon the claims and any equivalents thereof.

What is claimed is:

1. A diagnostic system associated with a train, the train in communication with a remote control station, the train including a plurality of wagons and locomotives, the diagnostic system comprising:
a diagnostic module on-board each of the plurality of wagons and the locomotives of the train, the diagnostic module configured to generate a signal indicative of at least one of operational data and health data associated with the corresponding wagon or the locomotives of the train; and
a communication module on-board a slave roiling stock and a master control module, wherein the slave rolling stock is configured to transmit the at least one of the operational data and the health data associated with the slave rolling stock to at least one of the master control module and the remote control station, and wherein the master control module is configured to at least one of:
exchange the at least one of the operational data and the health data associated with the master control module with another master control module located on at least one of the same train and another train;
forward the at least one of the operational data and the health data associated with the slave rolling stock to the remote control station; and
transmit the at least one of the operational data and the health data associated with the master control module to the remote control station.
